(19) United States
(12) Patent Application Publication
(10) Pub. No.: US 2004/0231604 A1
(43) Pub. Date: Nov. 25, 2004

(54) Pet Bed

(76) Inventor: Marilyn Ann Badler, Hayward, CA (US)

Correspondence Address: Marilyn Badler, 1335 E. Street, Hayward, CA, 94541, US

(21) Appl. No.: 10/395,665

(22) Filed: Mar. 24, 2003

(51) Int. Cl. A01K 29/00

(52) U.S. Cl. 119/28.5

(57) ABSTRACT

A pet bed of the type having two cushions, each having one straight edge which connects to a straight edge strip corresponding in length to each cushion, allowing straight strip to act as a hinge to facilitate proper closure when cushions are placed together to form base and cover.

Bed consists of three sections: top, bottom and hinge strip.

Top and bottom are padded cushions. Back side of each cushion is a straight edge. The shape of front and sides is variable.

Hinge strip corresponds in length to the straight edge of each cushion. Hinge strip is also padded. Hinge strip connects to the straight edge of each cushion. A hinge is formed. When cushions are placed together, a top and bottom form.

Connected only at the back, sides and front remain open.

### BACKGROUND—FIELD OF INVENTION

This application claims the benefit of Provisional Patent Application No. 60/367,158 and Design Patent No. USD 443,1165.

### BACKGROUND—DESCRIPTION OF PRIOR ART

Pet owners commonly provide a pet with a pet bed for resting comfort. The basic pet bed is a cushion on pad separating the pet from the floor or ground. In addition, a blanket on cloth may be provided to cover the pet. The pet may be covered by actions of the owner or of the pet itself. When the pet moves or leaves the bed, the blanket may be displaced.

Therefore, inventors created several types of pet beds which incorporated a cover. U.S. Pat. No. 5,357,901 to batts discloses a cushion with a single-layer cover attached to one end. To get beneath cover, pet must enter head first, lifting the cover with its nose, then turn around in a small enclosed area. It is possible that the pet could get trapped or even suffocated. It would be impossible for the pet to back in. Cover is flush with cushion. Pet would be unable to lift cover with rear legs or hindquarters. Once under, a single layer of material would not provide much additional warmth.

Several types of pet shelters have been proposed, for example U.S. Pat. No. DES319,271 to Simpkins. The distinct opening makes the bed less difficult to enter, but cover is above and not on pet, reducing the benefits of added warmth.

All pet beds heretofore thus suffer from one or more disadvantages:

a) difficult access;

b) cover is above, rather than resting on pet;

c) single layer of material provides little warmth;

d) separate, non integral cover;

e) cover attached over much of the base, as in shelter type;

f) not easily washable;

g) not easily portable;

h) potentially unsafe if pet were to get trapped in pocket between cover and base.

My own patents 60/367,158 and D443,116S describe a pet bed that is capable of both warmth and easy access. Accordingly, several objects and advantages of my invention are:

a) to provide easy access on both front and side;

b) to provide a warm cover that rests on pet;

c) to provide the comfort of insulating material such as polyfoam;

d) to provide a single unit with cover attached at the back leaviing sides open;

e) to provide integral base and cover construction which can be sewn or attached with velcro;

f) to provide a washable pet bed, either by removing covers over washable polyfoam or as separate sections;

g) to provide a portable pet bed;

h) to provide a pet covering based only on the action of gravity;

i) to provide safety as front and sides are open allowing pet to breathe and easily enter, open and exit;

j) to provide a basic structure adaptable to a wide range of embodiments, base and cover materials, fillings, shapes, sizes, attachment methods, stiching or patterning.

### DRAWING FIGURES

FIG. 1 is a top view of pet bed showing my new design and structure;

FIG. 2 is a front view;

FIG. 3 is a back view;

FIG. 4 is a side view;

FIG. 5 is a bottom view;

FIG. 6 is a view in open position;

FIG. 7 is a perspective view;

FIG. 8 is a perspecitve view.

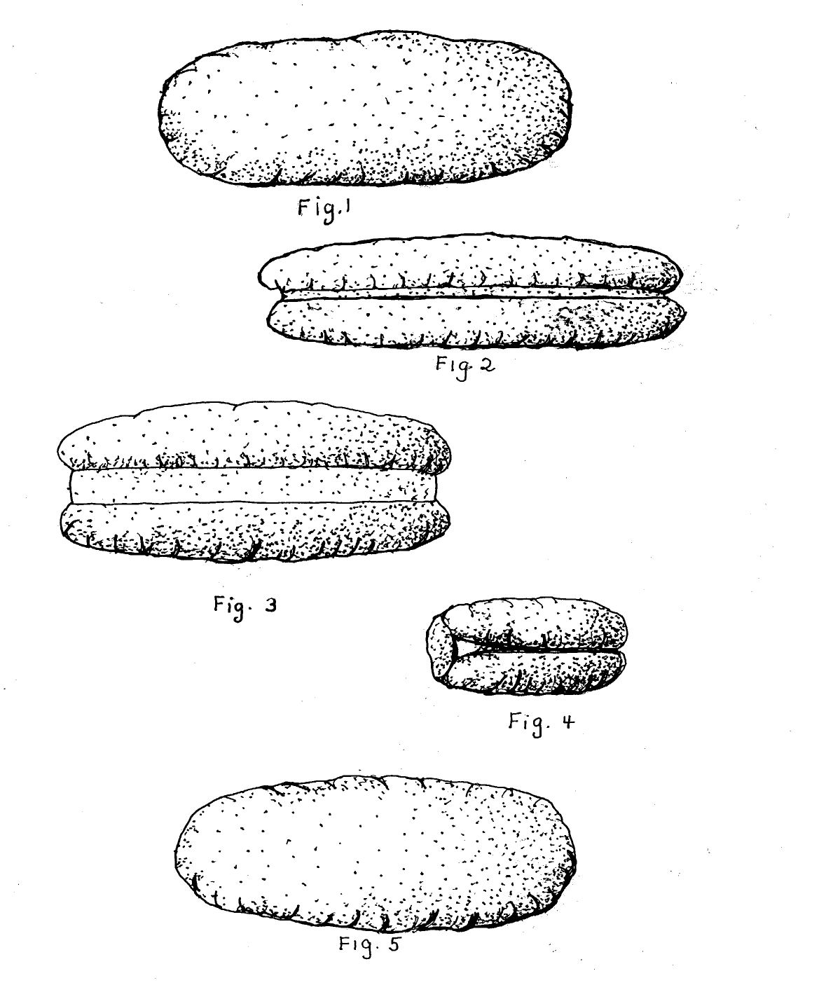

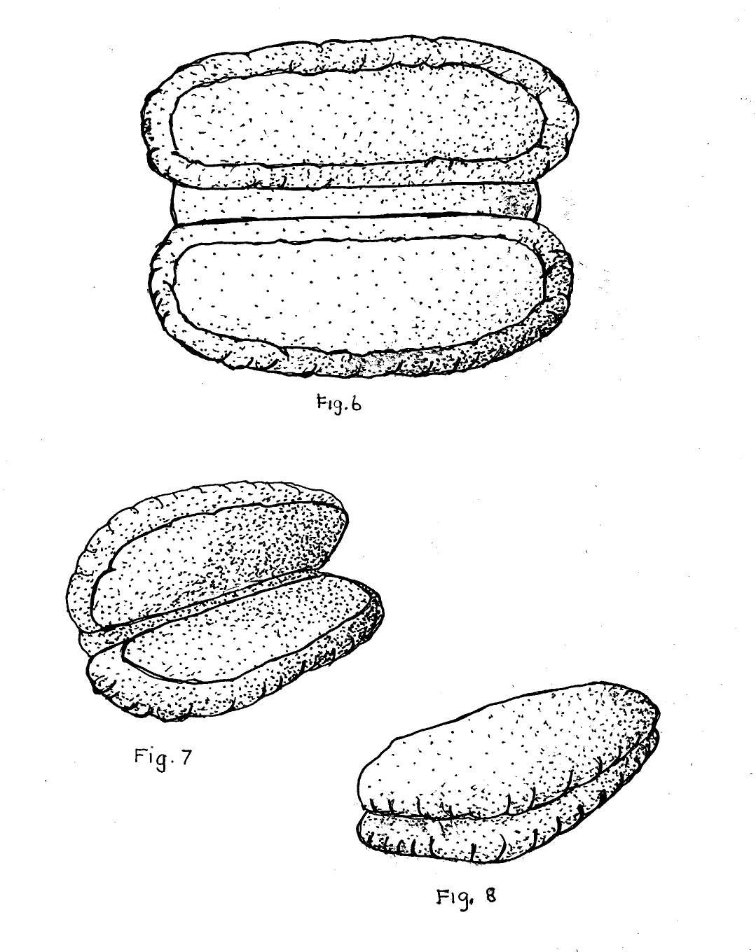

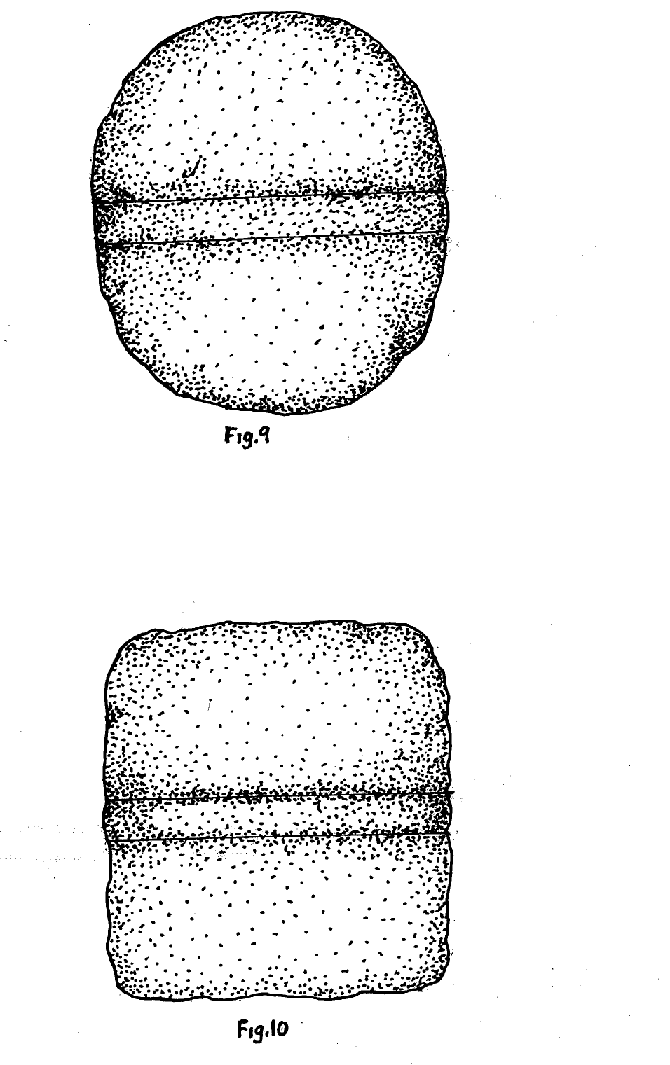

Additional embodiments are shown in FIGS. 9, 10, 11 and 12 is an open view.

### SUMMARY

My invention is a pet bed that meets all the objectives and provides all the advantages cited above.

### DESCRIPTION OF INVENTION

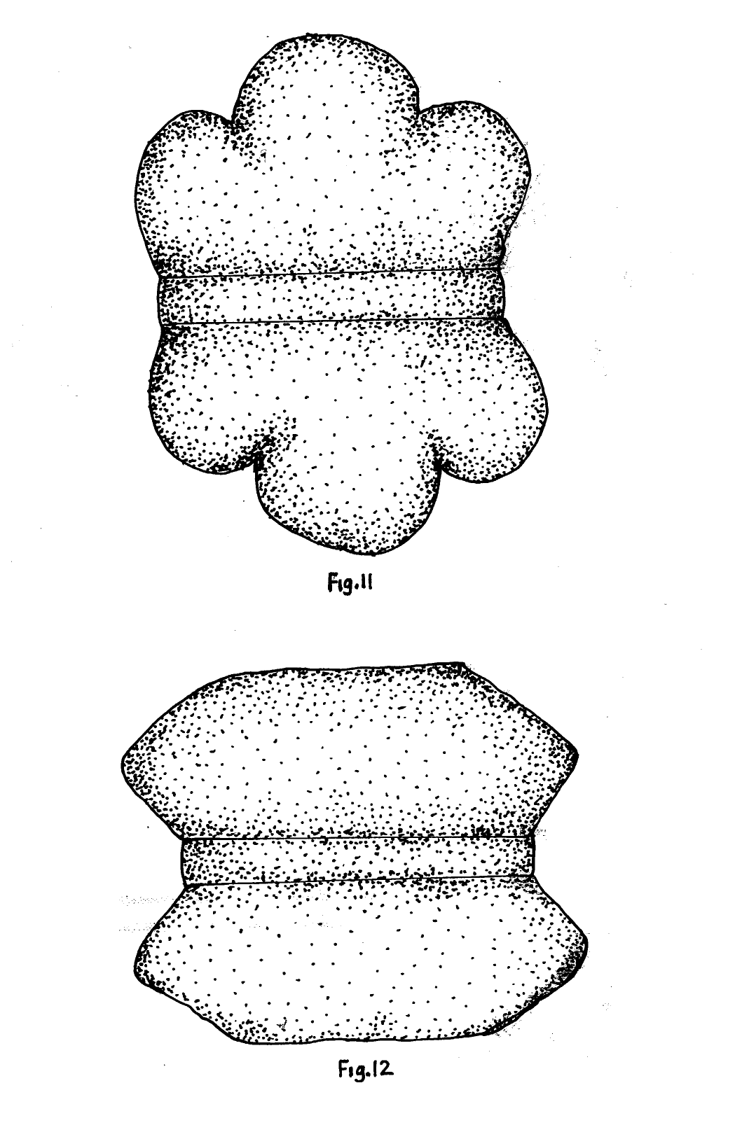

FIG. 7 shows a perspective view of my pet bed and illustrates its principal features. Pet bed consists of three sections: top, bottom and hinge strip. Top may be referred to as the cover. Bottom may be referred to as the base. Both top and bottom are padded cushions. The shape and material of top and bottom may be identical or different, depending on the desired design. Back side of each cushion is a straight edge. The shape of front and sides is variable. Hinge strip corresponds in length to the straight edge of each cushion. Hinge strip is also padded. Hinge strip connects to the straight edge of each cushion. A hinge is formed. When cushions are placed together, a cover and base are formed. Connected only at the back, sides and front remain open.

Exterior of pet bed is durable material such as leather, nylon, light-weight canvas or washable cloth. Interior adjacent to pet is fleece or other soft material. I prefer to extend exterior material inward to inner fleece and gather slightly. When bed is closed, only the exterior material shows. When open, the interior fleece shows. Stuffing is ployfill, foam rubber or cedar chips. Sections are connected by sewing or with velcro.

### OPERATION OF INVENTION

Pet bed is placed on suitable surface with the top cover positioned over the base. Pet enters between cushions, and gravity keeps top cushion gently covering pet. To avoid top flipping completely open, pet bed is simply positioned against a wall. The wall prevents the top from flipping too far. The back hinge is straight so pet bed adapts to any shape pet.

Front and sides are always open for easy entry and exit.

### CONCLUSIONS, RAMIFICATIONS AND SCOPE OF INVENTION

While above description contains many specificities, these should not be construed as limitations on the scope of the invention, but rather as an exemplification of one preferred embodiment thereof. Many variations are possible, many have been noted.

Accordingly, the scope of the invention should be determined not by the embodiment(s) illustrated, but by the appended claims and its legal equivalents.

1. (Cancelled).

2. A pet bed comprising a frist padded cushion member having a length and width each greater than its thickness and at least one linearly extending edge portion, a second padded cushion member having a length and width each greater than its thickness and at least one linearly extending edge portion, the said linearly extending edge portions of said first and second members being disposed in adjacent spaced relationship, linearly extending hinge means interposed between and connected to each of said edge portions, whereby said first and second members may be selectively moved from a first closed position in which said second member overlies said first member to a second open position in which said second member is disposed at an angel relative to said first member, said first and second members being of substantially the same length and width whereby all edges of said second member are substantially coterminous with and adjacent all the edges of said frist member when the members are in said closed position

3. A pet bed as claimed in claim 2 in which said second member may be positioned at an angle of about ninety degrees to said first member when in said open position.

4-6. (Cancelled).

7. A pet bed as set forth in claim 2 in which said hinge means includes a strip of padded cushion material secured along its edge to the respective linearly extending edge portions of said first and second members, and in which said strip maintains said respective linearly extending edge portions in generally parallel spaced apart relationship so as to permit pivoting of said first and second members between said open and closed positions.

8. A pet bed as set forth in claim 7 in which said frist and second members are substantially form retaining so as to permit said pivoting between open and closed positions.
